(19) United States
(12) Patent Application Publication
(10) Pub. No.: US 2017/0256792 A1
(43) Pub. Date: Sep. 7, 2017

(54) PRODUCTION PROCESS FOR CARBON-COATED SILICON MATERIAL

(71) Applicant: KABUSHIKI KAISHA TOYOTA JIDOSHOKKI, Kariya-shi, Aichi (JP)

(72) Inventors: Takeshi KONDO, Kariya-shi (JP); Yusuke SUGIYAMA, Kariya-shi (JP); Nobuhiro GODA, Kariya-shi (JP); Mutsumi TAKAHASHI, Kariya-shi (JP); Takashi MOHRI, Kariya-shi (JP); Tomohiro NIIMI, Kariya-shi (JP); Tomokuni ABE, Kariya-shi (JP); Hirotaka SONE, Kariya-shi (JP); Atsushi SAITO, Kariya-shi (JP); Akihiro SAEKI, Kariya-shi (JP)

(73) Assignee: KABUSHIKI KAISHA TOYOTA JIDOSHOKKI, Kariya-shi, Aichi (JP)

(21) Appl. No.: 15/506,529

(22) PCT Filed: Jul. 17, 2015
(86) PCT No.: PCT/JP2015/003623

§ 371 Date: Feb. 24, 2017

(30) Foreign Application Priority Data
Aug. 27, 2014 (JP) 2014-172926
Dec. 25, 2014 (JP) 2014-261449

(51) Int. Cl. H01M 4/36; H01M 4/04; H01M 10/0525; H01M 4/587; C01B 33/021; H01M 4/38

(52) U.S. Cl. CPC H01M 4/366; C01B 33/021; H01M 4/386; H01M 10/0525; H01M 4/587; H01M 4/0471; C01P 2006/40; H01M 2004/027

(57) ABSTRACT

A production process for carbon-coated silicon material includes the steps of:
a lamellar-silicon-compound production step of reacting CaSi₂ with an acid to turn the CaSi₂ into a lamellar silicon compound;
a silicon-material production step of heating the lamellar silicon compound at 300° C. or more to turn the lamellar silicon compound into a silicon material;
a coating step of coating the silicon material with carbon; and
a washing step of washing the silicon material, or another silicon material undergone the coating step, with a solvent of which the relative permittivity is 5 or more.

### TECHNICAL FIELD

The present invention relates to a production process for carbon-coated silicon material.

### BACKGROUND ART

Silicon materials have been known to be used as a constituent element for semiconductors, solar batteries, secondary batteries, and the like. Hence, studies on silicon materials have been carried out actively.

For example, Patent Application Publication No. 1 sets forth a silicon composite in which silicon oxide is coated with carbon by thermal CVD, and sets forth moreover a lithium-ion secondary battery which is furnished with the silicon composite as a negative-electrode active material.

Moreover, in Patent Application Publication No. 2, the present inventors reported the following: reacting CaSi₂ with an acid to synthesize a lamellar silicon compound from which Ca has been removed; heating the lamellar silicon compound at 300° C. or more to produce a silicon material from which hydrogen has broken away; and a lithium-ion secondary battery which is furnished with the silicon material as an active material.

In addition, in Patent Application Publication No. 3, the present inventors reported the following: reacting CaSi₂ with an acid to synthesize a lamellar silicon compound from which Ca has been removed; heating the lamellar silicon compound at 300° C. or more to produce a silicon material from which hydrogen has broken away; furthermore, producing a carbon/silicon composite in which the silicon material has been coated with carbon; and a lithium-ion secondary battery which is furnished with the composite as an active material.

### PATENT LITERATURE

Patent Application Publication No. 1: Japanese Patent Gazette No. 3952180;

Patent Application Publication No. 2: WO2014/080608; and

Patent Application Publication No. 3: Japanese Patent Application No. 2014-037833

### SUMMARY OF THE INVENTION

### Technical Problem

As described above, various silicon materials have been studied energetically. Moreover, industrial circles have sought for a more suitable silicon material and a production process for the same.

The present invention is made in view of such circumstances. An object of the present invention is to provide a silicon material, which is more suitable than are the conventional silicon materials, and a production process for the same.

### Solution to Problem

When the present inventors tried to wash the carbon-coated silicon material, which are being reported in Patent Application Publication No. 3, with a polar solvent during the course of earnest investigations, the present inventors discovered unexpectedly that lithium-ion secondary batteries using the post-washing carbon-coated silicon material maintained the capacities remarkably suitably. Thus, the present inventors completed the present invention based on such a discovery.

That is, a production process for carbon-coated silicon material according to the present invention comprises the steps of:

a lamellar-silicon-compound production step of reacting CaSi₂ with an acid to turn the CaSi₂ into a lamellar silicon compound;

a silicon-material production step of heating the lamellar silicon compound at 300° C. or more to turn the lamellar silicon compound into a silicon material;

a coating step of coating the silicon material with carbon; and

a washing step of washing the silicon material, or another silicon material undergone the coating step, with a solvent of which the relative permittivity is 5 or more.

### Advantageous Effects of the Invention

The present production process enables the industrial circles to provide a carbon-coated silicon material which is suitable as an active material for lithium-ion secondary battery.

### DESCRIPTION OF THE EMBODIMENTS

Some of best modes for executing the present invention are hereinafter explained. Note that, unless otherwise specified, numerical ranges, namely, “from ‘x’ to ‘y’” set forth in the present description, involve the lower limit, “x,” and the upper limit, “y” in the ranges. Moreover, the other numerical ranges are composable by arbitrarily combining any two of the upper-limit values and lower-limit values, involving the other numeric values enumerated in examples as well. In addition, selecting numeric values arbitrarily from within the ranges of numeric values enables other upper-limit and lower-limit numerical values to be set.

A production process for carbon-coated silicon material according to the present invention comprises the steps of:

a lamellar-silicon-compound production step of reacting CaSi₂ with an acid to turn the CaSi₂ into a lamellar silicon compound;

a silicon-material production step of heating the lamellar silicon compound at 300° C. or more to turn the lamellar silicon compound into a silicon material;

a coating step of coating the silicon material with carbon; and

a washing step of washing the silicon material, or another silicon material undergone the coating step, with a solvent of which the relative permittivity is 5 or more.

First of all, explanations are made on the lamellar-silicon-compound production step. The lamellar-silicon-compound production step is a step in which CaSi₂ is reacted with an acid to break away Ca therefrom, turning the CaSi₂ into a lamellar silicon compound.

In general, CaSi₂ comprises a structure in which a Ca layer and an Si layer are laminated.

As for the acid, the following are exemplified: hydrofluoric acid, hydrochloric acid, hydrobromic acid, hydroiodic acid, sulfuric acid, nitric acid, phosphoric acid, formic acid, acetic acid, methanesulfonic acid, tetrafluoroboric acid, hexafluorophosphoric acid, hexafluoroarsenic acid, fluoroantimonic acid, hexafluorosilicic acid, hexafluorogermanic acid, hexafluorostannic (IV) acid, trifluoroacetic acid, hexafluorotitanic acid, hexafluorozirconic acid, trifluoromethanesulfonic acid, and fluorosulfonic acid. Making use of one of the acids independently, or combining a plurality of the acids to employ, is allowed.

In particular, as for the acid, adopting an acid from which fluorine anions are capable of arising is preferable. Adopting the acid enables the following to decrease: Si—O bonds capable of arising in the lamellar silicon compound; and bonds occurring between Si and anions of the other acids, and capable of arising in the lamellar silicon compound (in the case of hydrochloric acid, Si—Cl bonds, for instance). Note that, when the Si—O bonds and Si—Cl bonds exist in the lamellar silicon compound, there possibly is such a case as the Si—O bonds and Si—Cl bonds still exist in the silicon material even if the lamellar silicon compound undergoes the silicon-material production step, the next step. Then, in a lithium-ion secondary battery adopting as a negative-electrode active material the silicon material which has the Si—O bonds and Si—Cl bonds, the Si—O bonds and Si—Cl bonds are presumed to hinder the movements of lithium ions.

The acid used at the lamellar-silicon-compound production step is used preferably more than CaSi₂ by molar ratio. Although carrying out the step without any solvent is allowed, adopting water as a solvent is preferable from the viewpoints of separating the targeted substance and removing by-products, such as CaCl₂. Reaction conditions of the step are set preferably so as to be done under a depressurized condition, such as in a vacuum; or in an inert-gas atmosphere. Moreover, the reaction conditions are set preferably so as to be done under a temperature condition of room temperature or less, such as in an ice bath. In addition, setting up a reaction time appropriately for the step is permitted.

When hydrochloric acid is used as the acid, the lamellar-silicon-compound production step comes to be expressed by the following ideal reaction equation.

3CaSi₂+6HCl→Si₆H₆+3CaCl₂

In the aforementioned reaction equation, the Si₆H₆ corresponds to an ideal lamellar silicon compound. Believing is also possible that, in the reaction, S—H bonds are formed while 2Hs, namely, two hydrogens, substitute for Ca in lamellar CaSi₂. The lamellar silicon compound is made lamellarly, because the basic skeleton of Si layers in the raw-material CaSi₂ is maintained.

In the lamellar-compound production step, carrying out the reaction in the presence of water is preferable. Moreover, since Si₆H₆ is capable of reacting with water, the lamellar silicon compound is hardly obtainable usually as such a compound as Si₆H₆, but is obtainable as compounds expressed by Si₆HₓOH_{y}X_{z} (where “X” is an element or group derived from anions of the acid, “x”+“y”+“z”=6, 0<“x”<6, 0<“y”<6, and 0<“z”<6). Note herein that no consideration is made as to inevitable impurities, such as Ca, which are capable of remaining in the lamellar silicon compound.

Next, explanations are made on the silicon-material production step. The step is a step in which the lamellar silicon compound is heated at 300° C. or more to have hydrogen or water, and the like, break away therefrom in order to obtain the silicon material.

When the silicon-material production step is expressed by an ideal reaction equation, the step comes to be as set forth below.

Si₆H₆→6Si+3H₂↑

However, since the lamellar silicon compound, which is used actually for the silicon-material production step, is not only compounds expressed by Si₆HₓOH_{y}X_{z} (where “X” is an element or group derived from anions of the acid, “x”+“y”+“z”=6, 0<“x”<6, 0<“y”<6, and 0<“z”<6) but also contains inevitable impurities, the silicon material, which is obtainable actually, turns into a material which is expressed by SiHᵤOᵥX_{w} (where “X” is an element or group derived from anions of the acid, 0<“u”+“v”+“w”<1, 0≦“u”<1, 0≦“v”<1, and 0≦“w”<1), and which further contains inevitable impurities as well. In the aforementioned formula for the silicon material, “u” falls preferably within a range of 0≦“u”<0.5, more preferably within a range of 0≦“u”<0.3, or much more preferably within a range of 0≦“u”<0.1. However, “u”=0 is the most preferable. In the aforementioned formula for the silicon material, “v” falls preferably within a range of 0≦“v”<0.7, more preferably within a range of 0≦“v”<0.5, much more preferably within a range of 0≦“v”<0.3, or especially preferably within a range of 0≦“v”≦0.2. In the aforementioned formula for the silicon material, “w” falls preferably within a range of 0≦“w”<0.7, more preferably within a range of 0≦“w”<0.5, much more preferably within a range of 0≦“w”<0.3, or especially preferably within a range of 0≦“w”≦0.2.

The silicon-material production step is carried out preferably in a nonoxidizing atmosphere of which the oxygen content is less than the oxygen content in an ordinary air atmosphere. As for the nonoxidizing atmosphere, reduced-pressure atmospheres including vacuum, and inert-gas atmospheres are exemplifiable. A preferable heating temperature falls within a range of from 350° C. to 1,200° C., or a more preferable heating temperature falls within a range of from 400° C. to 1,200° C. When the heating temperature is too low, such a case arises as hydrogen does not break away sufficiently; whereas the heating temperature being too high leads to the waste of energy. Setting up a heating time appropriately in compliance with the heating temperature is allowed. Moreover, while measuring an amount of hydrogen and the other elements getting out from a reaction system to the outside, determining the heating time is also preferred. Selecting the heating temperature and heating time appropriately makes also possible adjusting proportions of amorphous silicon and silicon crystallites included in the silicon material to be produced, and makes also possible adjusting sizes of the silicon crystallites. In addition, appropriately selecting the temperature and time makes possible even adjusting configurations and sizes of nanometer-level-thickness layers including the amorphous silicon and silicon crystallites included in the silicon material to be produced.

A size of the aforementioned silicon crystallites falls preferably within a range of from 0.5 nm to 300 nm, more preferably within a range of from 1 nm to 100 nm, much more preferably within a range of from 1 nm to 50 nm, or especially preferably within a range of from 1 nm to 10 nm. Note that the size of the silicon crystallites is computed by the Scherrer equation using the half-value width of a diffraction peak of Si (111) plane in an XRD chart which is obtained by carrying out an X-ray diffraction measurement (or XRD measurement) to the silicon material.

The aforementioned silicon-material production step makes obtainable the silicon material comprising a structure in which plate-shaped silicon bodies are laminated in a plurality of pieces in the thickness direction. The structure is ascertainable by observation with a scanning-type electron microscope, and the like. The plate-shaped silicon bodies have a structure in which nanometer-size silicon particles are arranged lamellarly. The “nanometer-size silicon particles” described herein are particles involving the above-described silicon crystallites which fall within a range of from 0.5 nm to 300 nm. The structures in which the plate-shaped silicon bodies are laminated in a plurality of pieces in the thickness direction are sometimes called “nanometer-size agglomerated particles.” When employing a later-described carbon-coated silicon material as an active material for lithium-ion secondary battery is taken into consideration, the silicon bodies preferably have a thickness falling within a range of from 10 nm to 100 nm, or more preferably have a thickness falling within a range of from 20 nm to 50 nm, in order for efficient insertion and elimination (or sorption and desorption) reactions of the lithium ions. Moreover, the plate-shaped silicon bodies preferably have a major-axis-direction length falling within a range of from 0.1 μm to 50 μm. In addition, the plate-shaped silicon bodies preferably exhibit a ratio, (Major-axis-direction Length)/(Thickness), falling within a range of from 2 to 1,000.

Next, explanations are made on the coating step. The coating step is a step in which the silicon material is coated with carbon to turn the silicon material into a carbon-coated silicon material serving as a carbon/silicon composite. To be concrete, the step is a step in which the silicon material is contacted with an organic substance, in a nonoxidizing atmosphere and under a heating condition, to form a carbon layer comprising the carbonized organic substance on a surface of the silicon material.

As for the organic substance, solid organic substances, liquid organic substances, and gaseous organic substances are available. In particular, using the gaseous-state organic substance makes possible not only forming a uniform carbon layer on an outer surface of the silicon material, but also forming the carbon layer even on a surface of the particles inside the silicon material. The process for generating a carbon film using the gaseous-state organic substance is an application of the process called commonly as a thermal CVD process. When a thermal CVD process is applied to carry out the coating step, using one of the following publicly-known CVD apparatuses is allowed: such fluidized-bed reactor furnaces as typified by hot-wall type, cold-wall type, horizontal type or vertical type; or such furnaces as a rotating furnace, tunnel furnace, batch-system calcination furnace or rotary kiln.

As for the organic substance, an organic substance, which is thermally decomposed by heating in a nonoxidizing atmosphere to be capable of carbonizing, is used. For example, one member or mixture, which is selected from the group consisting of the following, is given: saturated aliphatic hydrocarbons, such as methane, ethane, propane, butane, isobutane, pentane and hexane; unsaturated aliphatic hydrocarbons, such as ethylene, propylene and acetylene; alcohols, such as methanol, ethanol, propanol and butanol; aromatic or aromatic-series compounds, such as benzene, toluene, xylene, styrene, ethyl benzene, diphenyl methane, naphthalene, phenol, cresol, benzoic acid, salycylic acid, nitrobenzene, chlorobenzene, indene, benzofuran, pyridine, anthracene and phenanthrene; esters, such as ethyl acetate, butyl acetate, amyl acetate; fatty acids, and so on.

Although a treatment temperature at the coating step differs depending on kinds of the organic substance, desirable is setting the treatment temperature at a temperature which is higher by 50° C. or more than a temperature at which the organic substance decomposes thermally. However, selecting a condition under which no free carbon (or soot) generates is preferable, because such a case arises as the free carbon (or soot) generates within a system when a heating temperature is high excessively. A thickness of the carbon layer to be formed is controllable by setting up a treatment time appropriately.

Putting the silicon material in a fluidized state, and then carrying out the coating step are preferable. The coating step thus done enables the entire surface of the silicon material to contact with the organic substance, and makes possible forming a more uniform carbon layer. Although various methods, such as using a fluidized bed, are available for putting the silicon material in a fluidized state, having the silicon material contact with the organic substance while stirring the silicon material is preferable. For example, using a rotating furnace having a baffle plate in the interior enables a much more uniform carbon layer to form over the silicon material entirely, because the silicon material residing on the baffle plate falls down from a predetermined height as the rotating furnace rotates so that the silicon material is stirred to contact with the organic substance and then a carbon layer is formed under the circumstances.

The carbon layer on the carbon-coated silicon material is preferably amorphous and/or crystalline. Moreover, the carbon layer is preferred to cover the entire surface of particles comprising the silicon material. Note that the carbon layer is formed preferably on at least some of a surface of the aforementioned plate-shaped silicon bodies. A thickness of the carbon layer falls preferably within a range of from 1 nm to 100 nm, or more preferably within a range of from 10 to 50 nm. As for a preferred carbon layer, the carbon layer is formed in a thickness as uniform as possible. As such an index, the preferred carbon layer exhibits an average thickness “R” and a standard deviation “σ” of the thicknesses which satisfy Relational Expression (1): (“R”/“3σ”)>1. The average carbon-layer thickness “R,” and the standard deviation “σ” of the carbon-layer thicknesses are computable by observing a cross section of the carbon-coated silicon material to measure the carbon-layer thicknesses.

Moreover, the carbon-coated silicon material is allowed to turn into particles with a certain grain size distribution by undergoing pulverizing and classifying operations. As for a preferable grain size distribution for the carbon-coated silicon material, exemplifiable are grain size distributions of which D₅₀ falls within a range of from 1 to 30 μm when measured by a common laser-diffraction type grain-size-distribution measuring apparatus.

Next, explanations are made on the washing step of washing the silicon material and/or carbon-coated silicon material with a solvent of which the relative permittivity is 5 or more. The washing step is a step of removing unnecessary components, which adhere onto the silicon material and/or carbon-coated silicon material, by washing the material with a solvent (hereinafter, referred to sometimes as a “washing solvent”) of which the relative permittivity is 5 or more. In particular, the step is aimed at removing substances (e.g., components derived from the acid employed at the lamellar-silicon-compound production step, or calcium salts, and the like) which are capable of dissolving into the washing solvent. For example, when hydrochloric acid is used at the lamellar-silicon-compound production step, chlorine is presumed to exist as CaCl₂, or an element constituting Si—Cl bonds, in the silicon material or carbon-coated silicon material. Hence, washing the silicon material and/or carbon-coated silicon material with the washing solvent leads to dissolving salts, such as CaCl₂, into the washing solvent to make the salts removable. The washing step is also allowed to be done by a method of immersing the silicon material into the washing solvent, or is even permitted to be done by another method of pouring the washing solvent onto the silicon material. Likewise, the washing step is also allowed to be done by a method of immersing the carbon-coated silicon material into the washing solvent, or is even permitted to be done by another method of pouring the washing solvent onto the carbon-coated silicon material.

As for the washing solvent, a washing solvent of which the relative permittivity is higher is a preferable option, from a viewpoint of whether salts are likely to dissolve into the washing solvent. A washing solvent of which the relative permittivity is 10 or more, or even 15 or more, is presentable as a more preferable option. As for a range of the relative permittivity of the washing solvent, the relative permittivity falls preferably within a range of from 5 to 90, more preferably within a range of from 10 to 90, or much more preferably within a range of from 15 to 90. Moreover, as the washing solvent, using an independent solvent is also allowed, or even using a mixed solvent comprising a plurality of solvents is permitted.

As for specific examples of the washing solvent, the following are givable: water, methanol, ethanol, n-propanol, i-propanol, n-butanol, i-butanol, sec-butanol, tert-butanol, ethylene glycol, glycerin, N-methyl-2-pyrrolidone, N,N-dimethylformamide, N,N-dimethylacetamide, dimethyl sulfoxide, acetonitrile, ethylene carbonate, propylene carbonate, benzyl alcohol, phenol, pyridine, tetrahydrofuran, acetone, ethyl acetate, and dichloromethane. Adopting as the washing solvent a fluorine-substituted solvent, in which fluorine atoms have substituted for some or all of hydrogen atoms in the chemical structure of the specific solvents is also allowed. As for the water serving as the washing solvent, any of distilled water, water permeated through a reverse osmosis membrane and deionized water is preferable.

For reference, Table 1 shows the relative permittivities of various kinds of solvents.

TABLE 1

| Solvent | Relative Permittivity |
|---|---|
| Water | 80 |
| Methanol | 33 |
| Ethanol | 24 |
| n-Propanol | 20 |
| i-Propanol | 18 |
| n-Butanol | 18 |
| Ethylene Glycol | 39 |
| Glycerin | 43 |
| N-methyl-2-pyrrolidone | 32 |
| N,N-dimethylformamide | 38 |
| Dimethyl Sulfoxide | 47 |
| Acetonitrile | 37 |
| Ethylene Carbonate | 90 |
| Propylene Carbonate | 64 |
| Benzyl Alcohol | 13 |
| Phenol | 9.8 |
| Pyridine | 12 |
| Acetone | 21 |
| Dichloromethane | 9 |
| Tetrahydrofuran | 7.5 |
| Ethyl Acetate | 6 |

The following are solvents of which the relative permittivity is less than 5.

| | |
|---|---|
| Dimethyl Carbonate | 3 |
| Diethyl Carbonate | 3 |
| Ethyl Methyl Carbonate | 3 |
| Benzene | 2 |
| Cyclohexane | 2 |
| Diethyl Ether | 4 |

When a washing solvent having a nucleophilic substitution group, such as a hydroxyl group, is adopted at the washing step, a nucleophilic substitution reaction is able to occur to Si—Cl bonds, and so on, which the silicon material or carbon-coated silicon material is able to include. For example, when the washing solvent is water, because of the hydroxyl group of water carrying out a nucleophilic attack to the Si—Cl bonds, Si—OH bonds are formed in the silicon material or carbon-coated silicon material while Cl ions are eliminated therefrom. The nucleophilic substitution reaction leads to the silicon material or carbon-coated silicon material in which the Si—Cl bonds are diminished.

Note herein that, in a lithium-ion secondary battery adopting the carbon-coated silicon material having Si—Cl bonds as a negative-electrode active material, the Si—Cl bonds and lithium are believed to react to generate stable LiCl, or the Si—Cl bonds and lithium are believed to form stable coordinate bonds. That is, the existence of Si—Cl bonds is presumed to make a cause of the irreversible capacity in the negative electrode, or make a cause of the resistance of the negative electrode.

Consequently, when a washing solvent having a nucleophilic substitution group is adopted at the washing step, expecting is possible to decrease the irreversible capacity in the negative electrode, or to reduce the resistance of the negative electrode. Therefore, a preferred washing solvent is the washing solvent having a nucleophilic substitution group.

Moreover, when adopting the carbon-coated silicon material as a negative-electrode active material for lithium-ion secondary battery is taken into consideration, as for the washing solvent, the following are preferable: a solvent to be easily removed; a solvent soluble to a solvent for lithium-ion secondary battery, such as N-methyl-2-pyrolidone, used upon making a negative-electrode active-material layer for lithium-ion secondary battery; or a solvent identical with the solvent for lithium-ion secondary battery; or even a solvent employable as a nonaqueous solvent of an electrolytic solution for lithium-ion secondary battery.

When the above-mentioned circumstances into consideration, as for the washing solvent, the following are preferable: water, methanol, ethanol, n-propanol, i-propanol, n-butanol, i-butanol, sec-butanol, tert-butanol, N-methyl-2-pyrrolidone, N,N-dimethylformamide, N,N-dimethylacetamide, dimethyl sulfoxide, acetonitrile, ethylene carbonate, and propylene carbonate.

A preferable washing time at the washing step is for from one minute to three hours, a more preferable washing time is for from five minutes to two hours, or a much more preferable washing time is for from 10 minutes to 90 minutes. After washing the silicon material or carbon-coated silicon material, removing the washing solvent from the material by filtering and drying is preferred. Moreover, breaking the post-washing silicon material or carbon-coated silicon material into pieces is also allowed, or even passing the material through a sieve is permitted.

Repeating the washing step a plurality of rounds is also allowed. In doing so, even altering the washing solvent is permitted. For example, the following are also allowed: as the washing solvent for a first-round washing step, selecting water of which the relative permittivity is high remarkably; and then, as the washing solvent for a second-round washing step, adopting N-methyl-2-pyroridone soluble to water. Such a selection of the washing solvents not only leads to making possible efficiently removing components, such as salts, which are derived from the acid, but also resulting in making possible efficiently removing protonic solvents which are not preferable to reside or be left over.

Carrying out the washing step under a warming condition is preferable. As for the warming condition, being 40° C. or more to fall within a range of less than a boiling point of the washing solvent is preferable, or falling within a range of from 50° C. or more to a temperature with 10° C. subtracted from the washing-solvent boiling point (i.e., {(the washing-solvent boiling point)−10° C.}) is more preferable. As a specific preferable warming-temperature range when the washing solvent is water, from 60 to 90° C. is exemplifiable.

Carrying out the washing step under a stirring condition is preferable. As for a stirring apparatus, magnetic stirrers, and mixers provided with stirring blades are exemplifiable. A stirring rate falls preferably in a range of from one to 50,000 rpm, more preferably in a range of from 10 to 10,000 rpm, or much more preferably in a range of from 100 to 1,000 rpm.

Carrying out the washing step while doing an ultrasonic treatment is preferable. The ultrasonic treatment is carried out using an ultrasonic generator, such as an ultrasonic washing machine or an ultrasonic homogenizer. As for an ultrasonic condition, the frequency falls preferably within a range of from 10 to 500 kHz, more preferably within a range of from 15 to 400 kHz, or much more preferably within a range of from 20 to 300 kHz.

Combining the aforementioned warming condition, stirring condition and ultrasonic treatment appropriately to carry out the washing step is preferable. Carrying out the washing step under the warming condition, under the stirring condition, or while doing the ultrasonic treatment, leads to doing efficiently the washing of the silicon material or carbon-coated silicon material.

In the carbon-coated silicon material produced via the washing step (hereinafter, referred to sometimes as “washed carbon-coated silicon material”), components derived from the acid used in the lamellar-silicon-compound production step decrease remarkably. Consequently, when one gram of the washed carbon-coated silicon material is stirred in 10-g water for one hour, an amount of anions derived from the acid which elutes into water decreases remarkably, so an anionic concentration becomes 50 ppm or less roughly in the post-stirring water. Since the anions are capable of adversely affecting the charging and discharging reactions of secondary battery, the washed carbon-coated silicon material in which the anions hardly reside or are left over is suitable as an active material for secondary battery.

As the lower limit value of a range of the anionic concentration, one ppm, five ppm, 10 ppm, or 15 ppm are exemplifiable. As a specific example of the anions derived from the acid, halogen ions, such as fluorine ion, chlorine ion, bromine ion and iodide ion, are givable.

If so, as a condition for one of preferred modes of the carbon-coated silicon material according to the present invention, the following is givable: “When one gram of the carbon-coated silicon material is stirred in 10-g water for one hour, a halogen-ion concentration in the water (i.e., a halogen-ion concentration to the water) is 50 ppm or less.

Note that the production process for carbon-coated silicon material according to the present invention is done allowably in the order of the washing step and then the coating step. The order is permitted because washing the silicon material before the coating step enables the coating step to double as the post-washing drying step so that the number of steps is reducible.

The washed carbon-coated silicon material obtainable by the production process according to the present invention is employable as a negative-electrode active material for secondary battery, such as lithium-ion secondary batteries. Hereinafter, explanations are made on a secondary battery according to the present invention while exemplifying a lithium-ion secondary battery as one of representatives for the secondary battery. A lithium-ion secondary battery according to the present invention comprises the washed carbon-coated silicon material as a negative-electrode active material. To be concrete, the lithium-ion secondary battery according to the present invention comprises a positive electrode, a negative electrode including the washed carbon-coated silicon material as a negative-electrode active material, an electrolytic solution, and a separator.

The positive electrode comprises a current collector, and a positive-electrode active-material layer bound together onto a surface of the current collector.

A “current collector” refers to a chemically inactive high electron conductor for keeping an electric current flowing to electrodes during the discharging or charging operations of a lithium-ion secondary battery. As for the current collector, the following are exemplifiable: at least one member selected from the group consisting of silver, copper, gold, aluminum, tungsten, cobalt, zinc, nickel, iron, platinum, tin, indium, titanium, ruthenium, tantalum, chromium, and molybdenum; as well as metallic materials, such as stainless steels. Covering the current collector with a publicly-known protective layer is also allowed. Even using as the current collector one of the optional current collectors of which the surface is treated by a publicly-known method is permitted.

The current collector is enabled to have such a form as a foil, a sheet, a film, a linear shape, a rod-like shape, or a mesh. Consequently, as the current collector, a metallic foil, such as a copper foil, a nickel foil, an aluminum foil or a stainless-steel foil, is usable suitably, for instance. When the current collector has a foiled, sheeted or filmed form, a preferable thickness thereof falls within a range of from one μm to 100 μm.

The positive-electrode active-material layer includes a positive-electrode active material, as well as a conductive additive and/or a binding agent, if needed.

As for the positive-electrode active material, the following are givable: one of lamellar compounds such as LiₐNi_{b}Co_{c}Mn_{d}DₑO_{f} (where 0.2≦“a”≦2, “b”+“c”+“d”+“e”=1, 0≦“e”<1, “D” is at least one element selected from the group consisting of Li, Fe, Cr, Cu, Zn, Ca, Mg, S, Si, Na, K, Al, Zr, Ti, P, Ga, Ge, V, Mo, Nb, W and La, and 1.7≦“f”≦3); and Li₂MnO₃. Moreover, as the positive-electrode active material, the following are further givable: spinel, such as LiMn₂O₄ or Li₂Mn₂O₄; a solid solution constituted of a mixture of spinel and a lamellar compound; and a polyanion-based compound expressed by LiMPO₄, LiMVO₄ or Li₂MSiO₄ (where “M” in the formula is at least one member selected from the group consisting of Co, Ni, Mn and Fe). In addition, as the positive-electrode active material, the following are furthermore givable: tavorite-based compounds expressed by LiMPO₄F (where “M” is a transition metal), such as LiFePO₄F; and borate-based compounds expressed by LiMBO₃ (where “M” is a transition metal), such as LiFeBO₃. Any of the metallic oxides used as the positive-electrode active material is allowed to have a basic composition in accordance with the above-mentioned compositional formulas, and substituted metallic oxides in which another metallic element substitutes for the metallic element included in the basic composition are also employable as the positive-electrode active material. Moreover, as the positive-electrode active material, using is also possible a positive-electrode active material which does not include any lithium ion contributing to charging and discharging. For example, even using the following is possible: sulfur simple substance (S); compounds in which sulfur and carbon are composited; metallic sulfides, such as TiS₂; oxides, such as V₂O₅ and MnO₂; polyaniline and anthraquinone, as well as compounds including one of the aromatic compounds in the chemical structure; conjugate system materials, such as conjugated-diacetic acid system organic substances; and the other publicly-known materials. In addition, compounds having a stable radical, such as nitroxide, nitronyl nitroxide, galvinoxyl or phenoxyl radical, are also adopted allowably as the positive-electrode active material. When using a positive-electrode active material free of lithium, adding lithium ions in advance to the positive electrode and/or the negative electrode by a publicly-known method is needed. Note herein that, in order to add the lithium ions, using a compound including metallic lithium or the lithium ions is permitted.

In one of the aforementioned lamellar compounds such as LiₐNi_{b}Co_{c}Mn_{d}DₑO_{f} (where 0.2≦“a”≦2, “b”+“c”+“d”+“e”=1, 0≦“e”<1, “D” is at least one element selected from the group consisting of Li, Fe, Cr, Cu, Zn, Ca, Mg, S, Si, Na, K, Al, Zr, Ti, P, Ga, Ge, V, Mo, Nb, W and La, and 1.7≦“f”≦3), the values of “b,” “c” and “d” are not restricted at all especially, as far as the values satisfy the aforementioned conditions. However, the lamellar compounds exhibiting 0<“b”<1, 0<“c”<1 and 0<“d”<1 are allowed. Moreover, at least any of “b,” “c” and “d” falls preferably in such a range as 0<“b”<80/100, 0<“c”<70/100 or 10/100<“d”<1; more preferably in such a range as 10/100<“b”<68/100, 12/100<“c”<60/100 or 20/100<“d”<68/100; or much more preferably in such a range as 25/100<“b”<60/100, 15/100<“c”<50/100 or 25/100<“d”<60/100.

“a” falls preferably within such a range as 0.5≦“a”≦1.7, more preferably within such a range as 0.7≦“a”≦1.5, much more preferably within such a range as 0.9≦“a”≦1.3, or especially preferably within such a range as 1≦“a”≦1.2. As to “e” and “f,” numerical values falling within the ranges prescribed by the aforementioned formula are allowed, but exemplifying “e”=0 and “f”=2 is possible.

The conductive additive is added in order to enhance the electrically-conducting property of an electrode. Consequently, optionally adding the conductive additive is allowed when an electrode lacks the electrically-conducting property, so even not adding the conductive additive is permitted when an electrode is sufficiently good in the electrically-conducting property. As for the conductive additive, a chemically inactive high electron conductor is allowed, and accordingly the following are exemplified: carbonaceous fine particles, such as carbon black, graphite, acetylene black and KETJENBLACK (registered trademark); gas-phase-method carbon fibers (or vapor-grown carbon fibers (or VGCF)); and various metallic particles. One of the conductive additives is addable independently, or two or more thereof are combinable to add to the active-material layer.

A compounding proportion of the conductive additive within the active-material layer falls preferably in such a mass ratio as (Active Material):(Conductive Additive)=from 1:0.005 to 1:0.5; more preferably from 1:0.01 to 1:0.2; or much more preferably from 1:0.03 to 1:0.1. The compounding proportion is thus set because no electrically-conducting paths with good efficiency are formable when the conductive additive is too less; moreover, because not only the active-material layer worsens in the formability but also an electrode lowers in the energy density when the conductive additive is too much.

The binding agent is a constituent element which fastens the active material and conductive additive together onto a surface of the current collector to perform a role of maintaining the electrically-conducting networks within an electrode. As for the binding agent, the following are exemplifiable: fluorine-containing resins, such as polyvinylidene fluoride, polytetrafluoroethylene and fluorinated rubber; thermoplastic resins, such as polypropylene and polyethylene; imide-based resins, such as polyimide and polyamide-imide; alkoxysilyl group-containing resins; acrylic resins, such as poly(meth)acrylate; styrene-butadiene rubber (or SBR); and carboxymethyl cellulose. Adopting one of the binding agents independently, or adopting a plurality of the binding agents, is allowed.

A compounding proportion of the binding agent within the active-material layer falls preferably in such a mass ratio as (Active Material):(Binding Agent)=from 1:0.001 to 1:0.3; more preferably from 1:0.005 to 1:0.2; or much more preferably from 1:0.01 to 1:0.15. The compounding proportion is thus set because the formability of an electrode declines when the binding agent is too less; moreover, because the energy density of an electrode lowers when the binding agent is too much.

The negative electrode comprises a current collector, and a negative-electrode active-material layer bound together onto a surface of the current collector. As to the current collector, appropriately or adequately adopting one of the current collectors explained for the positive electrode is allowed. The negative-electrode active-material layer includes a negative-electrode active material, as well as a conductive additive and/or a binding agent, if needed.

As for the negative-electrode active material, a negative-electrode active material comprising the washed carbon-coated silicon material according to the present invention is allowed. Adopting the washed carbon-coated silicon material according to the present invention alone is also allowed, or even combining the washed carbon-coated silicon material according to the present invention with a publicly-known negative-electrode active material to use is permitted.

As to the conductive additive and binding agent to be used in the negative electrode, the conductive additive and binding agent explained for the positive electrode are adopted allowably in the same compounding proportions as described above appropriately or suitably.

As for a method of forming the active-material layer onto a surface of the current collector, the active material is allowed to be coated onto a surface of the current collector using a heretofore publicly-known method, such as a roll-coating method, a die-coating method, a dip-coating method, a doctor-blade method, a spray-coating method or a curtain-coating method. To be concrete, an active material, and a solvent, as well as a binding agent and/or a conductive additive, if needed, are mixed to prepare a slurry. As for the aforementioned solvent, the following are exemplifiable: N-methyl-2-pyrolidone, methanol, methyl isobutyl ketone, and water. After the slurry is coated onto a surface of the current collector, the slurry is dried thereon. For the purpose of enhancing the density of an electrode, even compressing the post-drying composition is permitted.

The electrolytic solution includes a nonaqueous solvent, and an electrolyte dissolved in the nonaqueous solvent.

As for the nonaqueous solvent, cyclic esters, linear or chain-shaped esters, ethers, and the like, are employable. As for the cyclic esters, the following are exemplifiable: ethylene carbonate, propylene carbonate, butylene carbonate, gamma-butyrolactone, vinylene carbonate, 2-methyl-gamma-butyrolactone, acetyl-gamma-butyrolactone, and gamma-valerolactone. As for the linear esters, the following are exemplifiable: dimethyl carbonate, diethyl carbonate, dibutyl carbonate, dipropyl carbonate, ethyl methyl carbonate, alkyl propionate ester, dialkyl malonate ester, alkyl acetate ester, and so forth. As for the ethers, the following are exemplifiable: tetrahydrofuran, 2-methyltetrahydrofuran, 1,4-dioxane, 1,2-dimethoxyethane, 1,2-diethoxyethane, and 1,2-dibutoxyethane. As for the nonaqueous solvent, adopting a compound, in which fluorine atoms have substituted for some or all of hydrogen atoms in the chemical structure of the aforementioned specific solvents, is also allowed.

As for the electrolyte, a lithium salt, such as LiClO₄, LiAsF₆, LiPF₆, LiBF₄, LiCF₃SO₃ or LiN(CF₃SO₂)₂, is exemplifiable.

As for the electrolytic solution, the following solution is exemplifiable: a solution comprising a lithium salt, such as LiClO₄, LiPF₆, LiBF₄ or LiCF₃SO₃, dissolved in a concentration of from 0.5 mol/L to 1.7 mol/L approximately in a nonaqueous solvent, such as ethylene carbonate, dimethyl carbonate, propylene carbonate or diethyl carbonate.

The separator is a constituent element which isolates the positive electrode and negative electrode from one another, but which lets lithium ions pass therethrough while preventing the two electrodes from contacting with one another to result in short-circuiting. As for the separator, the following are givable: synthetic resins, such as polytetrafluoroethylene, polypropylene, polyethylene, polyimide, polyamide, polyaramid (or aromatic polyamide), polyester, and polyacrylonitrile; polysaccharides, such as cellulose, and amylose; natural polymers, such as fibroin, keratin, lignin, and suberin; porous bodies using one member or plural members of electrical insulating materials, such as ceramics; nonwoven fabrics; or woven fabrics, and the like. Moreover, turning the separator into a multi-layered structure is also allowed.

Next, explanations are made on a process for manufacturing the lithium-ion secondary battery.

The positive electrode and negative electrode turned into a polar-plate subassembly, setting or inserting the separator between the positive electrode and the negative electrode, if needed. Making the polar-plate subassembly into any of the following types is allowed: a laminated type in which the positive electrode, the separator and the negative electrode are superimposed; or a rolled-around type in which the positive electrode, the separator and the negative electrode are rolled around. After connecting intervals from the positive-electrode current collectors and negative-electrode current collectors up to the positive-electrode terminals and negative-electrode terminals, which lead to the outside, with leads, and the like, for collecting electricity, providing the polar-plate subassembly with the electrolytic solution to complete a lithium-ion secondary battery is permitted. Moreover, the lithium-ion secondary battery according to the present invention is allowed to undergo charging and discharging operations which are practiced in a voltage range suitable for the types of active materials included in the electrodes.

A configuration of the lithium-ion secondary battery according to the present invention is not at all limited especially, and accordingly adoptable are various configurations, such as cylindered types, cornered types, coined types and laminated types.

Mounting the lithium-ion secondary battery according to the present invention in a vehicle is allowed. The vehicle is permitted to be a vehicle making use of electric energies produced by the present lithium-ion secondary battery for all or some of the power source, and is allowed to be electric vehicles or hybrid vehicles, and the like, for instance. When mounting the present lithium-ion secondary battery in the vehicle, connecting a plurality of the present lithium-ion secondary batteries in series is permitted to make an assembled battery. Other than the vehicle, as for instruments in which the present lithium-ion secondary battery is mounted, the following are givable: personal computers, portable communication gadgets, various home electric appliances driven by batteries, office devices, or industrial instruments, and so forth. Moreover, using the present lithium-ion secondary battery is allowed for the following: electric storage apparatuses and power smoothing apparatuses for wind-force power generation, photovoltaic power generation, hydraulic power generation, and other electric power systems; powers for vessel, or the like, and/or electric-power supply sources for auxiliary machine therefor; powers for aircraft, spacecraft, or the like, and/or electric-power supply sources for auxiliary machine therefor; supplementary power sources for vehicle in which electricity is not used for the power source; power sources for mobile household robot; power sources for system backup; power sources for uninterruptible power-supply apparatus; and electric storage apparatuses for temporarily storing electric power which is required for charging in charging stations, etc., for electric-powered vehicle.

Having been explained so far are the embodiment modes of the present invention. However, the present invention is not limited to the aforementioned embodying modes at all. The present invention is feasible in various modes, to which changes or modifications that one of ordinary skill in the art carries out are made, within a range not departing from the gist of the present invention.

### EXAMPLES

Hereinafter, examples and comparative examples are shown to describe the present invention more concretely. Note that the examples in the following descriptions do not limit the present invention at all. In the following descriptions, the term, “part,” means a part by mass, and the term, “%,” means a percentage by mass, unless otherwise specified especially.

### First Example

A carbon-coated silicon material and lithium-ion secondary battery according to a first example were made as described below.

### (i) Lamellar-Silicon-Compound Production Step

A mixed solution of 7-mL HF aqueous solution with 46%-by-mass concentration and 56-mL HCl aqueous solution with 36%-by-mass concentration was held at 0° C. in an ice bath. In an argon-gas atmosphere, the mixed solution was stirred after adding 3.3-g CaSi₂ to the mixed solution. The mixed solution was subjected to a temperature increase up to room temperature after confirming the completion of bubbling from a reaction liquid therein, and was further stirred for another two hours at room temperature. Thereafter, the mixed solution was furthermore stirred for extra 10 minutes after adding 20-mL distilled water to the mixed solution. On the occasion, a yellow-colored powder floated.

The obtained reaction liquid was filtered. The residual was washed with 10-mL ethanol after washing the residual with 10-mL distilled water, and was then vacuum dried to obtain 2.5-g lamellar silicon compound. Upon analyzing the lamellar silicon compound by a Raman spectrophotometer, a Raman spectrum in which peaks existed at 341±10 cm⁻¹, 360±10 cm⁻¹, 498±10 cm⁻¹, 638±10 cm⁻¹ and 734±10 cm⁻¹ was obtained.

### (ii) Silicon-Material Production Step

The aforementioned lamellar silicon compound was weighed out in an amount of one gram. Then, the lamellar silicon compound was subjected to a heat treatment, which was carried out while retaining the lamellar silicon compound at 500° C. for one hour in an argon-gas atmosphere of which the O₂ volume was 1% by volume or less, to obtain a silicon material. An X-ray diffraction measurement (or XRD measurement) using the CuK_{α} ray was carried out to the silicon material. A halo, which is believed to be derived from Si fine particles, was observed from the obtained XRD chart. Moreover, regarding Si, a size of the Si crystalline was about 7 nm, which was computed by the Scherrer equation using the half-value width of a diffraction peak of Si (111) plane in the XRD chart.

Note that, in the aforementioned heat treatment, the Si—H bonds of the lamellar silicon compound were cut off to separate the hydrogen atoms, and the cut-off and recombination of the Si—Si bonds occurred. The recombination of the Si—Si bonds not only occurred within the identical layers, but also was able to arise between the neighboring layers, and accordingly nanometer-size silicon primary particles having diameters at nanometer-size level were generated by the recombination. The nanometer-size silicon primary particles agglomerated each other to generate a silicon material serving as nanometer-size silicon agglomerated particles (or secondary particles). When the obtained silicon material was observed by a scanning-type electron microscope, the silicon material was found out to have a structure which was made by laminating plate-shaped silicon bodies in a plurality of pieces in the thickness direction. The plate-shaped silicon bodies were observed to have a thickness of from about 10 nm to about 100 nm, and were observed to have a length of from 0.1 μm to 50 μm in the major-axis direction.

### (iii) Coating Step

The aforementioned silicon material was put in a rotary kiln-type reactor vessel, and was then subjected to thermal CVD to obtain a carbon-coated silicon material. The thermal CVD was carried out under such conditions as at 850° C. and for 30-minute residence time in a propane-gas flow. The reactor vessel had a furnace core tube arranged in the horizontal direction. The furnace core tube was set to rotate at a revolving speed of one rpm. The furnace core tube had a baffle plate arranged on the inner peripheral wall. Thus, the reactor vessel was constructed so as to let contents, which deposited on the baffle plate as the furnace core tube rotated, fall down from the baffle plate at a predetermined height, and accordingly the contents were stirred by the construction.

When a cross section of the carbon-coated silicon material was observed by a scanning-type electron microscope, a carbon layer was found out to be formed on a surface of the silicon material.

### (iv) Washing Step

One gram of the aforementioned carbon-coated silicon material was added to 10-g pure water serving as the washing agent. Then, the carbon-coated silicon material and pure water were stirred by operating a mechanical stirrer (e.g., “RW20 DIGITAL” produced by AS-ONE Co., Ltd.) at 400 rpm, for five minutes and at room temperature, and were accordingly turned into a suspension liquid. Thereafter, to the suspension liquid, an ultrasonic treatment was carried out for 60 minutes by operating an ultrasonic washer (e.g., “USK-3R” produced by AS-ONE Co., Ltd.) at an oscillation frequency of 40 kHz. A carbon-coated silicon material according to a first example was obtained by filtering out powdered bodies from the obtained suspension liquid and then reduced-pressure drying the powdered bodies at 80° C. for 12 hours. Note that the used pure water was produced by a pure water producing apparatus (e.g., “AUTOSTILL WS200” produced by YAMATO SCIENTIFIC Co., Ltd.).

### (v) Lithium-Ion Secondary Battery

A slurry was prepared by mixing the following each other: the carbon-coated silicon material according to the first example serving as a negative-electrode active material in an amount of 70 parts by mass; natural graphite serving as another negative-electrode active material in an amount of 15 parts by mass; acetylene black serving as a conductive additive in an amount of 5 parts by mass; and a binder solution in an amount of 33 parts by mass. For the binder solution, a solution comprising a polyamide-imide resin dissolved in N-methyl-2-pyrrolidone in an amount of 30% by mass was used. The aforementioned slurry was coated onto a surface of an electrolyzed copper foil (serving as a current collector) of which the thickness was about 20 μm using a doctor blade, and was then dried to form a negative-electrode active-material layer on the copper foil. Thereafter, the current collector and the negative-electrode active-material layer were adhesion joined firmly by a roll pressing machine. The adhesion-joined substance was vacuum dried at 100° C. for 2 hours to form a negative electrode of which the negative-electrode active-material layer had a thickness of 16 μm.

Using as an evaluation electrode the negative electrode fabricated through the procedures mentioned above, a lithium-ion secondary battery (i.e., a half cell) was fabricated. A metallic lithium foil with 500 μm in thickness was set as the counter electrode.

The counter electrode was cut out to φ13 mm, and the evaluation electrode was cut out to φ11 mm. Then, a separator composed of a glass filter produced by HOECHST CELANESE Corporation and “Celgard 2400” produced by CELGARD Corporation was set or held between the two to make an electrode assembly. The electrode assembly was accommodated in a battery case (e.g., a member for CR2032-type coin battery, a product of HOSEN Co., Ltd.). A nonaqueous electrolytic solution was injected into the battery case. Note that the nonaqueous electrolytic solution comprised a mixed solvent composed of ethylene carbonate and diethyl carbonate mixed one another in a ratio of 1:1 by volume, and LiPF₆ dissolved in the mixed solvent in a concentration of 1 M. Then, the battery case was sealed hermetically to obtain a lithium-ion secondary battery according to the first example.

### Second Example

Except that the washing conditions at the washing step were set so that the stirring operation was done at 400 rpm and room temperature for 60 minutes, a carbon-coated silicon material and lithium-ion secondary battery according to a second example were obtained in the same manner as the first example.

### Third Example

Except that the washing conditions at the washing step were set so that the stirring operation was done at 400 rpm and 80° C. for 60 minutes, a carbon-coated silicon material and lithium-ion secondary battery according to a third example were obtained in the same manner as the first example.

### Fourth Example

Except that the washing solvent at the washing step was changed to N-methyl-2-pyrolidone (hereinafter, abbreviated sometimes to “NMP”), a carbon-coated silicon material and lithium-ion secondary battery according to a fourth example were obtained in the same manner as the first example.

### Fifth Example

Except that the washing solvent at the washing step was changed to methanol, and that the time for the stirring operation with the mechanical stirrer was extended to 60 minutes, a carbon-coated silicon material and lithium-ion secondary battery according to a fifth example were obtained in the same manner as the first example.

### Sixth Example

Except that the washing solvent at the washing step was changed to a mixed solvent comprising methanol and water in such a volumetric ratio as 1:1, a carbon-coated silicon material and lithium-ion secondary battery according to a sixth example were obtained in the same manner as the fifth example.

### Seventh Example

Except that the washing solvent at the washing step was changed to ethanol, a carbon-coated silicon material and lithium-ion secondary battery according to a seventh example were obtained in the same manner as the fifth example.

### Eighth Example

Except that the washing solvent at the washing step was changed to a mixed solvent comprising ethanol and water in such a volumetric ratio as 1:1, a carbon-coated silicon material and lithium-ion secondary battery according to an eighth example were obtained in the same manner as the fifth example.

### Ninth Example

Except that the temperature at the washing step was set at 50° C., a carbon-coated silicon material and lithium-ion secondary battery according to a ninth example were obtained in the same manner as the eighth example.

### Tenth Example

Except that the washing solvent at the washing step was changed to n-propanol, a carbon-coated silicon material and lithium-ion secondary battery according to a tenth example were obtained in the same manner as the fifth example.

### Eleventh Example

Except that the washing solvent at the washing step was changed to i-propanol, a carbon-coated silicon material and lithium-ion secondary battery according to an eleventh example were obtained in the same manner as the fifth example.

### Twelfth Example

Except that the washing solvent at the washing step was changed to n-butanol, a carbon-coated silicon material and lithium-ion secondary battery according to a twelfth example were obtained in the same manner as the fifth example.

### Thirteenth Example

Except that the washing solvent at the washing step was changed to i-butanol, a carbon-coated silicon material and lithium-ion secondary battery according to a thirteenth example were obtained in the same manner as the fifth example.

### Fourteenth Example

Except that the washing solvent at the washing step was changed to sec-butanol, a carbon-coated silicon material and lithium-ion secondary battery according to a fourteenth example were obtained in the same manner as the fifth example.

### Fifteenth Example

Except that the washing solvent at the washing step was changed to tert-butanol, a carbon-coated silicon material and lithium-ion secondary battery according to a fifteenth example were obtained in the same manner as the fifth example.

### Sixteenth Example

Except that the washing solvent at the washing step was changed to N,N-dimethylformamide (hereinafter, abbreviated sometimes to “DMF”), a carbon-coated silicon material and lithium-ion secondary battery according to a sixteenth example were obtained in the same manner as the fifth example.

### Seventeenth Example

Except that the washing solvent at the washing step was changed to N,N-dimethylacetamide (hereinafter, abbreviated sometimes to “DMA”), a carbon-coated silicon material and lithium-ion secondary battery according to a seventeenth example were obtained in the same manner as the fifth example.

### Eighteenth Example

Except that the washing solvent at the washing step was changed to dimethyl sulfoxide (hereinafter, abbreviated sometimes to “DMSO”), a carbon-coated silicon material and lithium-ion secondary battery according to an eighteenth example were obtained in the same manner as the fifth example.

### Nineteenth Example

Except that the washing solvent at the washing step was changed to acetonitrile, a carbon-coated silicon material and lithium-ion secondary battery according to a nineteenth example were obtained in the same manner as the fifth example.

### Twentieth Example

Except that the washing solvent at the washing step was changed to propylene carbonate, a carbon-coated silicon material and lithium-ion secondary battery according to a twentieth example were obtained in the same manner as the fifth example.

### First Comparative Example

Except that no washing step was carried out, a carbon-coated silicon material and lithium-ion secondary battery according to a first comparative example were obtained in the same manner as the first example.

### Second Comparative Example

Except that the washing solvent at the washing step was changed to dimethyl carbonate (hereinafter, abbreviated sometimes to “DMC”), a carbon-coated silicon material and lithium-ion secondary battery according to a second comparative example were obtained in the same manner as the first example.

### Third Comparative Example

Except that the washing solvent at the washing step was changed to diethyl carbonate (hereinafter, abbreviated sometimes to “DEC”), a carbon-coated silicon material and lithium-ion secondary battery according to a third comparative example were obtained in the same manner as the first example.

### First Evaluative Example

To the carbon-coated silicon materials according to the first through twentieth example and first comparative example, the following test was carried out.

One gram of the respective carbon-coated silicon materials was stirred within 10-g water for one hour to turn the carbon-coated silicon materials and water into suspension liquids. After filtering the respective suspension liquids, fluorine- and chlorine-ion concentrations in the obtained filtrates were measured by ion chromatography. Table 2 shows the results. Note that the used water was produced by a pure-water producing apparatus (e.g., “AUTOSTILL WS200” produced by YAMATO SCIENTIFIC Co., Ltd.).

TABLE 2

| | | | Sum of Fluorine- |
|---|---|---|---|
| | Washing | Washing | and Chlorine-ion |
| | Solvent | Conditions | Concentrations |
| 1st Ex. | Water | Room Temp., 5-min | 20 ppm |
| | | Stirring and 60-min | |
| | | Ultrasonic Treatment | |
| 2nd Ex. | Water | Room Temp., and | 40 ppm |
| | | 60-min Stirring | |
| 3rd Ex. | Water | 80° C. and 60- | 25 ppm |
| | | min Stirring | |
| 4th Ex. | NMP | Room Temp., 5-min | 48 ppm |
| | | Stirring and 60-min | |
| | | Ultrasonic Treatment | |
| 5th Ex. | Methanol | Room Temp., 60-min | 40 ppm |
| | | Stirring and 60-min | |
| | | Ultrasonic Treatment | |
| 6th Ex. | Methanol | Room Temp., 60-min | 35 ppm |
| | and Water | Stirring and 60-min | |
| | | Ultrasonic Treatment | |
| 7th Ex. | Ethanol | Room Temp., 60-min | 40 ppm |
| | | Stirring and 60-min | |
| | | Ultrasonic Treatment | |
| 8th Ex. | Ethanol | Room Temp., 60-min | 35 ppm |
| | and Water | Stirring and 60-min | |
| | | Ultrasonic Treatment | |
| 9th Ex. | Ethanol | 50° C., 60-min | 25 ppm |
| | and Water | Stirring and 60-min | |
| | | Ultrasonic Treatment | |
| 10th Ex. | n-Propanol | Room Temp., 60-min | 43 ppm |
| | | Stirring and 60-min | |
| | | Ultrasonic Treatment | |
| 11th Ex. | i-Propanol | Room Temp., 60-min | 46 ppm |
| | | Stirring and 60-min | |
| | | Ultrasonic Treatment | |
| 12th Ex. | n-Butanol | Room Temp., 60 min | 40 ppm |
| | | Stirring and 60-min | |
| | | Ultrasonic Treatment | |
| 13th Ex. | i-Butanol | Room Temp., 60-min | 42 ppm |
| | | Stirring and 60-min | |
| | | Ultrasonic Treatment | |
| 14th Ex. | sec-Butanol | Room Temp., 60-min | 48 ppm |
| | | Stirring and 60-min | |
| | | Ultrasonic Treatment | |
| 15th Ex. | tert-Butanol | Room Temp., 60-min | 42 ppm |
| | | Stirring and 60-min | |
| | | Ultrasonic Treatment | |
| 16th Ex. | DMF | Room Temp., 60-min | 44 ppm |
| | | Stirring and 60-min | |
| | | Ultrasonic Treatment | |
| 17th Ex. | DMA | Room Temp., 60-min | 45 ppm |
| | | Stirring and 60-min | |
| | | Ultrasonic Treatment | |
| 18th Ex. | DMSO | Room Temp., 60-min | 45 ppm |
| | | Stirring and 60-min | |
| | | Ultrasonic Treatment | |
| 19th Ex. | Acetonitrile | Room Temp., 60-min | 30 ppm |
| | | Stirring and 60-min | |
| | | Ultrasonic Treatment | |
| 20th Ex. | Propylene | Room Temp., 60-min | 42 ppm |
| | Carbonate | Stirring and 60-min | |
| | | Ultrasonic Treatment | |
| 1st Comp. | Not Applicable | Not Applicable | 350 ppm |
| Ex. | | | |

The washing step was thus supported to remarkably decline the concentration of the anions which were derived from the acids in the carbon-coated silicon materials.

### Second Evaluative Example

The lithium-ion secondary batteries according to the first through twentieth examples and first through third comparative examples were subjected to a discharging mode or operation which was carried out with a current of 0.2 mA and at a temperature of 25° C., and were subsequently subjected to a charging mode or operation which was carried out with a current of 0.2 mA and at a temperature of 25° C. {(“Charged Capacities”/“Discharged Capacities”)×100} were computed for the charging and discharging modes or operations, and were labeled as “Initial Efficiency (%),” respectively.

In addition, each of the lithium-ion secondary batteries was subjected to cyclic modes or operations which were carried out repeatedly for 30 cycles as follows: a discharging mode or operation which was carried out with a current of 0.2 mA and at a temperature of 25° C. until a voltage of the evaluation electrode became 0.01 V to the counter electrode; after 10 minutes had passed since the discharging mode or operation, a charging mode or operation which was carried out with a current of 0.2 mA and at a temperature of 25° C. until a voltage of the evaluation electrode became 1 V to the counter electrode; and an intermitting or pausing mode or operation for 10 minutes. Such a value as [100×{(“Post-30-cylcle Charged Capacity”)/(“Post-1-cycle Charged Capacity”)}] was computed, and was labeled as “Capacity Maintained Rate.” Note that, in the second evaluative example, “having Li occlude (or sorb) in the evaluation electrode” is referred to as “discharging,” and “having Li release (or desorb) from the evaluation electrode” is referred to as “charging.” Table 3 shows the results.

TABLE 3

| | | | | Capacity |
|---|---|---|---|---|
| | Washing | Washing | Initial | Maintained |
| | Solvent | Conditions | Efficiency | Rate |
| 1st Ex. | Water | Room Temp., 5-min Stirring | 75% | 90% |
| | | and 60-min Ultrasonic Treat. | | |
| 2nd Ex. | Water | Room Temp., and 60-min Stirring | 75% | 87% |
| 3rd Ex. | Water | 80° C. and 60-min Stirring | 75% | 90% |
| 4th Ex. | NMP | Room Temp., 5-min Stirring | 75% | 89% |
| | | and 60-min Ultrasonic Treat. | | |
| 5th Ex. | Methanol | Room Temp., 60-min Stirring | 75% | 91% |
| | | and 60-min Ultrasonic Treat. | | |
| 6th Ex. | Methanol and Water | Room Temp., 60-min Stirring | 75% | 90% |
| | | and 60-min Ultrasonic Treat. | | |
| 7th Ex. | Ethanol | Room Temp., 60-min Stirring | 75% | 89% |
| | | and 60-min Ultrasonic Treat. | | |
| 8th Ex. | Ethanol and Water | Room Temp., 60-min Stirring | 75% | 88% |
| | | and 60-min Ultrasonic Treat. | | |
| 9th Ex. | Ethanol and Water | 50° C., 60-min Stirring | 75% | 90% |
| | | and 60-min Ultrasonic Treat. | | |
| 10th Ex. | n-Propanol | Room Temp., 60-min Stirring | 75% | 88% |
| | | and 60-min Ultrasonic Treat. | | |
| 11th Ex. | i-Propanol | Room Temp., 60-min Stirring | 75% | 87% |
| | | and 60-min Ultrasonic Treat. | | |
| 12th Ex. | n-Butanol | Room Temp., 60 min Stirring | 75% | 85% |
| | | and 60-min Ultrasonic Treat. | | |
| 13th Ex. | i-Butanol | Room Temp., 60-min Stirring | 75% | 84% |
| | | and 60-min Ultrasonic Treat. | | |
| 14th Ex. | sec-Butanol | Room Temp., 60-min Stirring | 75% | 88% |
| | | and 60-min Ultrasonic Treat. | | |
| 15th Ex. | tert-Butanol | Room Temp., 60-min Stirring | 75% | 88% |
| | | and 60-min Ultrasonic Treat. | | |
| 16th Ex. | DMF | Room Temp., 60-min Stirring | 75% | 84% |
| | | and 60-min Ultrasonic Treat. | | |
| 17th Ex. | DMA | Room Temp., 60-min Stirring | 75% | 84% |
| | | and 60-min Ultrasonic Treat. | | |
| 18th Ex. | DMSO | Room Temp., 60-min Stirring | 75% | 84% |
| | | and 60-min Ultrasonic Treat. | | |
| 19th Ex. | Acetonitrile | Room Temp., 60-min Stirring | 75% | 88% |
| | | and 60-min Ultrasonic Treat. | | |
| 20th Ex. | Propylene | Room Temp., 60-min Stirring | 75% | 88% |
| | Carbonate | and 60-min Ultrasonic Treat. | | |
| 1st Comp. | Not Applicable | Not Applicable | 73% | 83% |
| Ex. | | | | |
| 2nd Comp. | DMC | Room Temp., 5-min Stirring | 72% | 45% |
| Ex. | | and 60-min Ultrasonic Treat. | | |
| 3rd Comp. | DEC | Room Temp., 5-min Stirring | 68% | 75% |
| Ex. | | and 60-min Ultrasonic Treat. | | |

The lithium-ion secondary batteries according to the first through twentieth examples were superior to the lithium-ion secondary batteries according to the first through third comparative examples in both of the initial efficiency and capacity maintained rate.

The results of the first evaluative example and second evaluative example supported that the washing step in the production process according to the present invention removes undesirable impurities to make suitable carbon-coated silicon materials obtainable.

### Twenty-First Example

A carbon-coated silicon material and lithium-ion secondary battery according to a twenty-first example were made as described below.

### (i) Lamellar-Silicon-Compound Production Step

A mixed solution of 7-mL HF aqueous solution with 46%-by-mass concentration and 56-mL HCl aqueous solution with 36%-by-mass concentration was held at 0° C. in an ice bath. In an argon-gas atmosphere, the mixed solution was stirred after adding 3.3-g CaSi₂ to the mixed solution. The mixed solution was subjected to a temperature increase up to room temperature after confirming the completion of bubbling from a reaction liquid therein, and was further stirred for another two hours at room temperature. Thereafter, the mixed solution was furthermore stirred for extra 10 minutes after adding 20-mL distilled water to the mixed solution. On the occasion, a yellow-colored powder floated.

The obtained reaction liquid was filtered. The residual was washed with 10-mL ethanol after washing the residual with 10-mL distilled water, and was then vacuum dried to obtain 2.5-g lamellar silicon compound.

### (ii) Silicon-Material Production Step

The aforementioned lamellar silicon compound was subjected to a heat treatment, which was carried out while retaining the lamellar silicon compound at 500° C. for one hour in an argon-gas atmosphere of which the O₂ volume was 1% by volume or less, to obtain a silicon material.

### (iii) Coating Step

The aforementioned silicon material was put in a rotary kiln-type reactor vessel, and was then subjected to thermal CVD to obtain a carbon-coated silicon material. The thermal CVD was carried out under such conditions as at 850° C. and for 30-minute residence time in a propane-gas flow in a furnace core tube which rotated at a revolving speed of one rpm.

### (iv) Washing Step

100 g of the aforementioned carbon-coated silicon material was added to 150-mL pure water serving as the washing agent. Then, the carbon-coated silicon material and pure water were stirred by operating a mechanical stirrer (e.g., “RW20 DIGITAL” produced by AS-ONE Co., Ltd.) at 400 rpm, for 60 minutes and at room temperature, and were accordingly turned into a suspension liquid. After filtering the obtained suspension liquid, powdered bodies was reduced-pressure dried at 120° C. for five hours. The post-drying powdered bodies were broken into pieces in a mortar, and were then passed through a sieve to obtain a carbon-coated silicon material according to the twenty-first example. Note that the used pure water was produced by a pure water producing apparatus (e.g., “AUTOSTILL WS200” produced by YAMATO SCIENTIFIC Co., Ltd.).

### (v) Lithium-Ion Secondary Battery

A slurry was prepared by mixing the following each other: the carbon-coated silicon material according to the twenty-first example serving as a negative-electrode active material in an amount of 70 parts by mass; natural graphite serving as another negative-electrode active material in an amount of 15 parts by mass; acetylene black serving as a conductive additive in an amount of 5 parts by mass; and a binder solution in an amount of 33 parts by mass. For the binder solution, a solution comprising a polyamide-imide resin dissolved in N-methyl-2-pyrrolidone in an amount of 30% by mass was used. The aforementioned slurry was coated onto a surface of an electrolyzed copper foil (serving as a current collector) of which the thickness was about 20 μm using a doctor blade, and was then dried to form a negative-electrode active-material layer on the copper foil. Thereafter, the current collector and the negative-electrode active-material layer were adhesion joined firmly by a roll pressing machine. The adhesion-joined substance was vacuum dried at 100° C. for 2 hours to form a negative electrode of which the negative-electrode active-material layer had a thickness of 16 μm.

A positive electrode was made as described below.

A slurry was prepared by mixing the following each other: LiNi_{b}Co_{c}Mn_{d}O₂ (where “b”+“c”+“d”=1) serving as a positive-electrode active material; acetylene black serving as a conductive additive; polyvinylidene fluoride serving as a binder; and N-methyl-2-pyrrolidone. An aluminum foil with a thickness of 20 μm was readied to serve as a current collector for positive electrode. Onto a surface of the aluminum foil, the aforementioned slurry was coated so as to be in the shape of a film using a doctor blade. The N-methyl-2-pyrrolidone was removed by drying the aluminum foil with the slurry coated thereon at 80° C. for 20 minutes. Thereafter, the aluminum foil with the active-material layer formed thereon was pressed to obtain a joined substance. The obtained joined substance was heat dried at 120° C. for six hours with a vacuum drier to obtain an aluminum foil with the positive-electrode active-material layer formed thereon. The aluminum foil with the positive-electrode active-material layer formed thereon was used as a positive electrode.

Between the positive electrode and the negative electrode, a rectangle-shaped sheet serving as a separator and comprising a polypropylene/polyethylene/polypropylene three-layered-construction resinous film with 27×32 mm in size and 25 μm in thickness was interposed or held to make a polar-plate subassembly. After covering the polar-plate subassembly with laminated films in which two pieces made a pair and then sealing the laminated films at the three sides, an electrolytic solution was injected into the laminated films which had been turned into a bag shape. As for the electrolytic solution, a solution was used: the solution comprised a solvent in which ethylene carbonate and diethyl carbonate had been mixed with one another in such a volumetric ratio as 3:7; and LiPF₆ dissolved in the solvent so as to make one mol/L. Thereafter, the remaining one side was sealed to obtain a laminated-type lithium-ion secondary battery according to the twenty-first example in which the four sides were sealed air-tightly and in which the polar-plate subassembly and electrolytic solution were closed hermetically. Note that the positive electrode and negative electrode were equipped with a tab connectable electrically with the outside, respectively, and the tabs extended out partially to the outside of the laminated-type lithium-ion secondary battery.

### Fourth Comparative Example

Except that no washing step was carried out, a carbon-coated silicon material and lithium-ion secondary battery according to a fourth comparative example were obtained in the same manner as the twenty-first example.

### Third Evaluative Example

Each of the lithium-ion secondary batteries according to the twenty-first example and fourth comparative example were subjected to charging and discharging modes or operations which were carried out between two voltages, namely, from 2.5 V to 4.5 V, at a rate of 1 C. The thus obtained discharged capacities were labeled an initial capacity of each of the batteries.

The respective batteries were subjected to a charging mode or operation which was carried out up to 85% of the SOC (or the state of charge). Then, the post-charging respective batteries were held to stand still in a 60° C. constant-temperature chamber, and were then stored therein for 30 days.

The respective post-storing batteries were subjected to the charging and discharging modes or operations which were carried out between two voltages, namely, from 2.5 V to 4.5 V, at a rate of 1 C. The thus obtained discharged capacities were labeled a post-storing capacity of each of the batteries. A post-storing capacity maintained rate of the respective batteries was computed by the following equation. Table 4 shows the results. Note that the results shown in Table 4 are an average value when N=2, respectively.

Post-storing Capacity Maintained Rate (%)={(Post-storing Capacity)/(Initial Capacity)}×100

TABLE 4

| | Post-storing |
|---|---|
| | Capacity |
| | Maintained Rate |
| Twenty-first Ex. | 78% |
| Fourth Comp. Ex. | 69% |

A lithium-ion secondary battery comprising a carbon-coated silicon material according to the present invention was supported to excel in the post-storing capacity maintained rate as well.

1. A production process for carbon-coated silicon material, the production process comprising the steps of:
a lamellar-silicon-compound production step of reacting CaSi₂ with an acid to turn the CaSi₂ into a lamellar silicon compound;
a silicon-material production step of heating the lamellar silicon compound at 300° C. or more to turn the lamellar silicon compound into a silicon material;
a coating step of coating the silicon material with carbon; and
a washing step of washing the silicon material, or another silicon material undergone the coating step, with a solvent of which the relative permittivity is 5 or more.

2. The production process for carbon-coated silicon material as set forth in claim 1, wherein the carbon-coated silicon material is produced in the order of the silicon-material production step, the washing step, and the coating step.

3. The production process for carbon-coated silicon material as set forth in claim 1, wherein the solvent has a relative permittivity of 15 or more.

4. The production process for carbon-coated silicon material as set forth in claim 1, wherein the solvent comprises one or more members selected from the group consisting of water, methanol, ethanol, n-propanol, i-propanol, n-butanol, i-butanol, sec-butanol, tert-butanol, N-methyl-2-pyrrolidone, N,N-dimethylformamide, N,N-dimethylacetamide, dimethyl sulfoxide, acetonitrile, ethylene carbonate, and propylene carbonate.

5. The production process for carbon-coated silicon material as set forth in claim 1, wherein the washing step is carried out under such a warming condition as being from 40° C. or more to less than a boiling point of the solvent.

6. The production process for carbon-coated silicon material as set forth in claim 1, wherein the washing step is carried out under a stirring condition.

7. The production process for carbon-coated silicon material as set forth in claim 1, wherein the washing step is carried out while doing an ultrasonic treatment.

8. A manufacturing process for secondary battery comprising a step of manufacturing a negative electrode using a carbon-coated silicon material produced by the production process as set forth in claim 1.

9. A carbon-coated silicon material exhibiting a halogen-ion concentration of 50 ppm or less in water when one gram of the carbon-coated silicon material is stirred in 10-g water for one hour.

10. The carbon-coated silicon material as set forth in claim 9 comprising:
nanometer-size silicon agglomerated particles in which plate-shaped silicon bodies are laminated in a plurality of pieces in a thickness direction thereof, the plate-shaped silicon bodies having a structure in which nanometer-size silicon particles are arranged lamellarly; and
a carbon layer formed on at least some of a surface of the plate-shaped silicon bodies, and having a thickness falling within a range of from 1 nm to 100 nm.

11. The carbon-coated silicon material as set forth in claim 10 comprising the carbon layer exhibiting an average thickness “R” and a standard deviation “σ” of thicknesses thereof, the average thickness “R” and standard deviation “σ” satisfying Relational Expression (1) set forth below:
(“R”/“3σ”)>1. Relational Expression (1)

12. A secondary battery comprising the carbon-coated silicon material as set forth in claim 9, the carbon-coated silicon material serving as a negative-electrode active material.
